(19) United States
(12) Patent Application Publication
(10) Pub. No.: US 2020/0333619 A1
(43) Pub. Date: Oct. 22, 2020

(54) AN IMAGING DEVICE FOR MOTOR VEHICLE

(71) Applicant: Continental Automotive GmbH, Hannover (DE)

(72) Inventors: Kah Soon Ang, Singapore (SG); Cornelius Koburg, Singapore (SG); You Shing Ngim, Singapore (SG)

(21) Appl. No.: 16/960,404

(22) PCT Filed: Jan. 7, 2019
(86) PCT No.: PCT/EP2019/050212

§ 371 Date: Jul. 7, 2020

(30) Foreign Application Priority Data
Jan. 8, 2018 (GB) 1800222.0

(51) Int. Cl. G02B 27/62; G02B 5/20; G02B 7/02; H04N 5/225; H04N 17/00; B60R 11/04; B60K 35/00

(52) U.S. Cl. CPC G02B 27/62; G02B 5/208; G02B 7/021; G02B 7/025; B60R 2011/0003; H04N 5/2254; H04N 17/002; B60R 11/04; B60K 35/00; H04N 5/2253

(57) ABSTRACT

An imaging device suitable for a motor vehicle and a method of providing the same is disclosed herein. The imaging device has an optical assembly arranged using a plurality of lenses and an image sensor to convert light rays received by the optical assembly. Specifically, the optical assembly comprises of a plurality of lenses stacked together. The optical assembly and image sensor are aligned using an active alignment process with six degrees of freedom in a x, y and z-axis, which determines a position of the optical assembly relative to the image sensor.

### TECHNICAL FIELD

This disclosure relates to imaging devices. In particular, an imaging device suitable for use within an interior of a motor vehicle is disclosed herein.

### BACKGROUND

Imaging devices are commonly used for facial or biometric recognition applications. Specifically for vehicular applications, such imaging devices are integrated into a display unit such that the imaging device is able to capture the interior of a passenger compartment, to monitor a state of the interior of passenger compartment for security purposes, or for monitoring a driver's condition. The display unit may be mounted onto an instrument cluster placed before a driver, for instance.

Typical problem associated with imaging devices for use in vehicular environment includes optical aberration. Types of optical aberration includes manufacturing defects in lenses or misalignment of lenses with image sensor during fabrication of imaging devices, which result in poor quality of images captures, for example poor focus or blurring of images.

It is an object to provide an imaging device that solves the problem of optical aberration. Other advantages of the subject disclosure will be apparent through the exemplary embodiments provided herein.

### SUMMARY

In a first aspect of this disclosure, an imaging device for a motor vehicle is provided. The imaging device may comprise of an optical assembly having a plurality of lenses and an image sensor configured to convert light rays received by the optical assembly into electrical signals. The optical assembly and the image sensor may be aligned according to a six degree of freedom in a x, y and z-axis. Advantageously, the aforesaid setup produces sharper images with improved depth of view.

Preferably, the alignment of the optical assembly and the image sensor may be achieved using an active alignment process, wherein the plurality of lenses are aligned with the image sensor with six degrees of freedom in a x, y and z-axis. The plurality of lenses of the optical assembly may individually be adjusted in three Cartesian coordinate axes, namely x, y and z-axis, relative to the image sensor so that the centre axis of each lens matches or substantially matches the centre axis of the other lenses as well as the centre axis of the image sensor. When the centre axis of each lens matches or substantially matches the centre axis of the other lenses as well as the centre axis of the image sensor, optical aberration is eliminated and sharper images are produced. Each lens may be moved and rotated about the image sensor in the x, y and z-axis (i.e. translational and rotational motion), thereby achieving the six degrees of freedom.

As mentioned above, the optical assembly includes a plurality of lenses. The plurality of lenses may be two or more spherical lenses, two or more aspherical lenses or a combination of both types of lenses, stacked together. An advantage of the optical assembly arranged through lens stacking is the optimization of space and improvement in focus length. Aspherical lenses reduce optical aberration more efficiently than spherical lenses, although the former is less economical than the latter. Thus, using a combination of both types of lenses balances economy and space requirements.

The optical assembly may further comprise a casing for housing the plurality of lenses. The benefit of having a casing to house the plurality of lenses prevents the optical assembly from dust and damage during handling.

The imaging device may comprise additional elements to suit the application. For example, the imaging device may comprise of a bandpass filter to allow a selected frequency range to pass through to the image sensor. The bandpass filter may be an infrared bandpass filter, allowing only light rays within the infrared spectrum to pass through.

To eliminate undesirable vibrations or improve vibration isolation, the optical assembly may include one or more vibration absorption means to absorb vibrations. Suitable vibration absorption means include retaining rings, circlips, clamps or flexures, depending on the design specification, although elastomeric retaining rings is ideal in a motor vehicle environment.

In addition, an adhesive force may be applied between the plurality of lenses (i.e. the optical assembly) and the image sensor to retain the alignment of the optical assembly and the image sensor.

The image device may further comprise a processing circuitry to electronically convert electrical signals form the image sensor into images.

In a second aspect of this disclosure, an instrument cluster of a motor vehicle having an imaging device according to this disclosure is provided.

In a third aspect of this invention disclosure, a mobile communication device having an imaging device according to this disclosure is provided.

Ina fourth aspect of this invention disclosure, a method of providing an imaging device for a motor vehicle according to this disclosure is provided. The method comprises the steps of (1) supplying an optical assembly for receiving light rays, (2) supplying an image sensor for converting the received light rays into electrical signals, and (3) actively aligning the optical assembly relative to the image sensor with six degrees of freedom in a x, y and z-axis.

Advantageously, the achievement of perfect alignment between the optical assembly and the image sensor reduces optical aberrations, thereby producing sharper images.

### BRIEF DESCRIPTION OF DRAWINGS

Other objects and aspects will become apparent from the following description of embodiments with reference to the accompany drawings in which:

FIG. 1 shows a drawing of an imaging device in accordance to a preferred embodiment of this disclosure.

FIG. 2 shows a side view of an imaging device 100 connected to different electronic components within an instrument cluster 200 of a motor vehicle in accordance to a preferred embodiment of this disclosure.

FIG. 3 shows flowchart 300 illustrating a method for providing an imaging device in accordance to a preferred embodiment of this disclosure.

### DETAILED DESCRIPTION OF EMBODIMENTS

Hereinafter, exemplary embodiments of this disclosure be discussed in details.

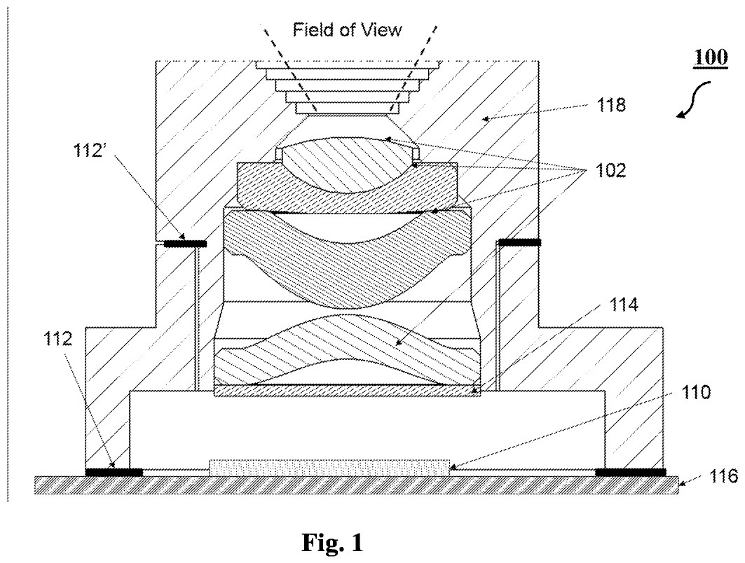

With reference to FIG. 1, an imaging device 100 according to a preferred embodiment of this disclosure is provided. The imaging device 100 comprises of an optical assembly 102, arranged using a plurality of lenses 104, 106, 108 aligned with an image sensor 110. In operation, the optical assembly 102 receives light rays from outside the imaging device, and the image sensor 110 converts the light rays received by the optical assembly 102 into electrical signals. Ideally, the optical assembly 102 and the image sensor 110 are aligned using an active alignment process with six degrees of freedom.

Each degree of freedom represents the freedom to move along or rotate about each Cartesian coordinate axis, i.e. x, y and z-axis. In this sense, the maximum amount of freedom is at six degrees of freedom, to move along each axis, and freedom to rotate about each of the axis.

In theory, to prevent optical aberration, the optical assembly 102 and the image sensor 110 are aligned as accurately as possible, to ensure quality of images captured. However, during manufacturing process, a perfect alignment is not possible due to tolerance in the optical assembly 102 and image sensor 110. In order to maximise the performance and accuracy of the imaging device, an alignment process is required to calibrate the optical assembly 102, i.e. the plurality of lenses 104, 106, 108, over the imaging sensor 110. Such optical alignment process may be passive or active. In a preferred embodiment, an active alignment process is applied to align the plurality of lenses 104, 106 and 108 to the image sensor 110 during mounting process. An active alignment process may be done by a machine or by an operator, to adjust the optical assembly 102 and the image sensor 110, to maximise imaging device performance, i.e. sharpest image possible. This alignment is done by moving the optical assembly 102 in each of the Cartesian coordinate axis, i.e. x, y and z-axis and also rotating about each of the aforesaid axis until a sharpest image is achieved, to determine a position of the optical assembly 102 relative to the image sensor 110.

An adhesive force 112, for example glue, may be pre-applied before commencing the active alignment process. Thereafter, the adhesive force 112 is cured by applying UV curing process. The adhesive force 112 may be applied around the perimeter of the optical assembly 102 and also around the perimeter of the image sensor 110. The aforesaid steps ensures the position of the optical assembly 102 is kept in place.

For prevention of dust from environment, a casing is used to house the optical assembly 102. In a preferred embodiment, the optical assembly 102 includes a bandpass filter 114, to allow light rays within a desired spectrum to pass through. One example is to use an infrared (IR) bandpass filter, such that only wavelengths within the infrared spectrum are received by the optical assembly 102.

To increase imaging device performance, a vibration absorption means (not shown) is included in the optical assembly 102 to absorb or isolate vibrations.

Once the image sensor 110 receives and convert light rays received by the optical assembly 102 into electrical signals, a processing circuitry electronically converts the electrical signals into images. In a preferred embodiment, the processing circuitry 116 is a printed circuit board (PCB) connected directly to the imaging device 100.

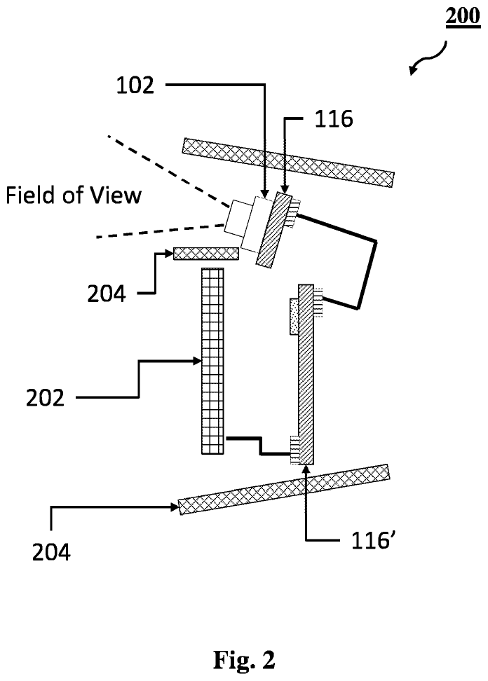

In an alternative embodiment, the processing circuitry is a main printed circuit board (PCB) of an instrument cluster, as shown in FIG. 2, which shows a side view of an imaging device 100 connected to different electronic components within an instrument cluster 200 of a motor vehicle. Within the instrument cluster 200, an imaging device 100 having an optical assembly 102 and an image sensor 110 is connected to a processing circuitry 116, which is further connected to a main printed circuit board (PCB) of the instrument cluster 200 by means of cables or wirings. The main PCB is electrically connected to a display unit 202, within a cluster mask structure 204 of an instrument cluster 202.

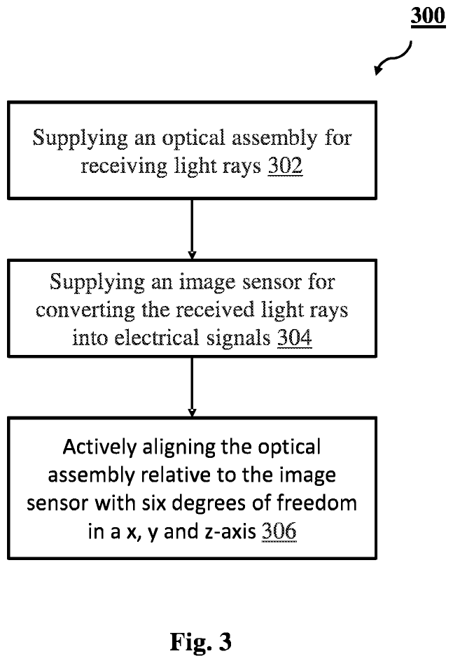

Turning now to FIG. 3 which shows flowchart 300 illustrating a method for providing an imaging device in accordance to a preferred embodiment of this disclosure. At step 302, an optical assembly is provided. The optical assembly is arranged using a plurality of spherical lenses, aspherical lenses or a combination thereof. At step 304, an image sensor is provided. At step 306, an active alignment process is applied to determine a position of the optical assembly relative to the image sensor. The position has a six degree of freedom in a x, y and z-axis. That is, at step 304, the optical assembly is actively aligned, i.e. continuously adjusted with six degrees of freedom, relative to the image sensor so as to achieve alignment.

1. An imaging device for a motor vehicle, comprising:
an optical assembly comprising a plurality of lenses; and
an image sensor configured to convert light rays received by the optical assembly into electrical signals.

2. The imaging device of claim 1, wherein the optical assembly and the image sensor are aligned using an active alignment process with six degrees of freedom in a x, y and z-axis.

3. The imaging device of claim 2, wherein the six degree of freedom in the x, y and z-axis determines a position of the optical assembly relative to the image sensor.

4. The imaging device of claim 1, wherein the plurality of lenses are spherical lenses, aspherical lenses or a combination thereof.

5. The imaging device of claim 1, wherein the optical assembly further comprises a casing for housing the plurality of lenses.

6. The imaging device according to claim 1, wherein the optical assembly comprises a bandpass filter to allow a selected frequency range to pass through to the image sensor.

7. The imaging device according to claim 6, wherein the bandpass filter is an infrared bandpass filter.

8. (canceled)

9. The imaging device according to claim 2, wherein an adhesive force is applied between the plurality of lenses and the image sensor to retain the alignment of the optical assembly and the image sensor.

10. The imaging device according to claim 1, wherein the imaging device further comprises a processing circuitry to electronically convert electrical signals from the image sensor into images.

11. An instrument cluster of a motor vehicle having an imaging device according to claim 1.

12. A mobile communication device having an imaging device according to claim 1.

13. A method of providing an imaging device for a motor vehicle according to claim 1, the method comprising:
supplying an optical assembly for receiving light rays;
supplying an image sensor for converting the received light rays into electrical signals; and
actively aligning the optical assembly relative to the image sensor with six degrees of freedom in a x, y and z-axis.
